(19) United States
(12) Patent Application Publication
(10) Pub. No.: US 2006/0188009 A1
(43) Pub. Date: Aug. 24, 2006

(54) Frame synchronization using soft decisions in a universal mobile telephone system receiver

(76) Inventors: Louis Robert Litwin, Plainsboro, NJ (US); Joshua Lawrence Koslov, Hopewell, NJ (US)

Correspondence Address: THOMSON LICENSING INC., PATENT OPERATIONS, PO BOX 5312, PRINCETON, NJ, 08543-5312, US

(21) Appl. No.: 10/565,447

(22) PCT Filed: Aug. 4, 2003
(86) PCT No.: PCT/US03/24527

§ 371 Date: Jan. 20, 2006

(51) Int. Cl. H04B 1/707

(52) U.S. Cl. 375/149

(57) ABSTRACT

A Universal Mobile Telephone System (UMTS) receiver performs frame synchronization in accordance with a soft decision technique. Illustratively, the UMTS receiver first forms a matrix of correlation peak values (350) from at least one received frame, each row of the matrix representing a possible SSCH code and each column of the matrix representing a slot position of an SCH frame. The UMTS receiver then forms a metric (355) for each cyclic shift of each one of 64 possible scrambling code groups from the matrix of correlation peak values and identifies the metric with the highest value (360). Having identified the highest metric value (360), the UMTS receiver uses the scrambling code group (365) and offset associated thereto (370) to complete frame synchronization.

### BACKGROUND OF THE INVENTION

The present invention generally relates to wireless receiving devices, and more particularly, to user equipment (UE) in a spread-spectrum based wireless system such as the Universal Mobile Telephone System (UMTS).

The basic unit of time in UMTS radio signals is a 10 milli-second (ms) radio frame, which is divided into 15 slots of 2560 chips each. UMTS radio signals from a cell (or base station) to a UMTS receiver are “downlink signals,” while radio signals in the reverse direction are termed “uplink signals.” When a UMTS receiver is first turned on, the UMTS receiver performs a “cell search” to search for a cell to communicate with. In particular, and as described below, the UMTS receiver initially looks for a downlink synchronization channel (SCH) transmitted from the cell to synchronize thereto at the slot and frame levels, and to determine the particular scrambling code group of the cell. Only after a successful cell search can voice/data communications begin.

With respect to the cell search, the SCH is a sparse downlink channel that is only active during the first 256 chips of each slot. The SCH is made up of two subchannels, the Primary SCH (PSCH) and the Secondary SCH (SSCH). The PSCH 256 chip sequence, or PSCH code, is the same in all slots of the SCH for all cells. In contrast, the SSCH 256 chip sequence, or SSCH code, is different in each of the 15 slots of a radio frame and is used to identify one of 64 possible scrambling code groups. In other words, each radio frame of the SCH repeats a scrambling code group sequence associated with the respective transmitting cell. Each SSCH code is taken from an alphabet of 16 possible SSCH codes.

As part of the cell search, the UMTS receiver first uses the PSCH to achieve slot synchronization. In this regard, the UMTS receiver correlates received samples of the received PSCH against the known PSCH 256 chip sequence (which is the same for all slots) and, based on the location of the correlation peak, determines a slot reference time. Once the slot reference time is determined, the UMTS receiver is slot synchronized and can determine when each slot starts in a received radio frame.

After slot synchronization, the UMTS receiver ceases processing of the PSCH and begins processing the SSCH. As noted above, the SSCH channel repeats a scrambling code group sequence associated with the respective transmitting cell. As such, a UMTS receiver must first determine which of the 64 possible scrambling code groups is being received, and then determine the number of slots in the offset between an estimate of the frame start by the UMTS receiver and the actual frame start to acquire frame synchronization. The typical approach is to use a hard decision technique. For example, in each slot the received signal is correlated against the 16 SSCH codes of the alphabet. The SSCH code with the strongest correlation is used as an estimate of the received SSCH code for that slot. The resulting 15 SSCH code estimates across 15 slots are then compared to all 15 possible shifts of all 64 possible scrambling code groups to identify the received scrambling code group and to determine the frame offset. (In UMTS, the scrambling code group sequences are defined a priori such that their cyclic-shifts are unique, i.e., a cyclic shift of any scrambling code group sequence is not equivalent to any other scrambling code group sequence.) Identification of the scrambling code group then enables the UMTS receiver to descramble all of the other downlink channels of the cell (e.g., the Common Pilot Channel (CPICH)) for voice/data communications to begin.

Unfortunately, the above-described SSCH portion of the cell search process is the most time consuming part. In particular, because of the low signal-to-noise ratios in which a UMTS system may operate, a UMTS receiver processes a predefined number of received radio frames, e.g., 10 to 20, in order to get a good estimate of the transmitted sequence of 15 SSCH codes from the cell. As such, since each radio frame is 10 ms long, a user may experience a delay on the order of at least 100 to 200 ms before voice/data communications can begin.

### SUMMARY OF THE INVENTION

As described above, a UMTS receiver performs the SSCH portion of the cell search by processing a predefined number of received radio frames. However, we have observed that the use of a hard decision technique for determining the received SSCH code in a particular slot may result in some degradation of performance under severe channel conditions since, once a decision is made as to which SSCH code was received in a particular slot, information related to other possibly received SSCH codes for that slot is discarded. For example, the hard decision technique selects the SSCH code associated with the largest correlation peak. As such, if the largest correlation peak in comparing the received signal to one of the 16 possible SSCH codes had a value of 1025 and the next largest correlation peak (and perhaps the one associated with the correct SSCH code) had a value of 1020, the latter information relating to the next largest correlation peak (and correct SSCH code) is discarded. As such, in some situations—especially when operating under severe channel conditions—the wrong SSCH codes are identified as being received by the wireless receiver.

Therefore, and in accordance with the principles of the invention, a wireless receiver receives a synchronization word comprising a plurality of codewords, or symbols, over a number of time slots, where the S symbols are associated with a synchronization word taken from a set of M synchronization words, where S>I and M>I; and acquires frame synchronization with respect to the number of time slots by estimating the associated synchronization word as a function of metric values associated with each of the M synchronization words.

In accordance with an embodiment of the invention, the UMTS receiver is a part of the UMTS user equipment (UE) and includes a processor and associated memory. The processor first performs slot synchronization using the PSCH. After achieving slot synchronization, the processor performs frame synchronization by forming, in the associated memory, a matrix of correlation peak values from at least one received frame, each row of the matrix representing a possible SSCH code and each column of the matrix representing a slot position of an SCH frame. The processor then forms a metric for each cyclic shift of each one of 64 possible scrambling code groups from the matrix of correlator peak values and identifies the metric having the highest metric value. Having identified the highest metric value, the processor uses the scrambling code group and offset associated thereto to complete frame synchronization.

In accordance with another embodiment of the invention, a UMTS receiver performs frame synchronization in accordance with a soft decision method. Illustratively, the UMTS receiver first forms a matrix of correlation peak values from at least one received frame, each row of the matrix representing a possible SSCH code and each column of the matrix representing a slot position of an SCH frame. The UMTS receiver then forms a metric for each cyclic shift of each one of 64 possible scrambling code groups from the matrix of correlation peak values and identifies the metric with the highest value. Having identified the highest metric value, the UMTS receiver uses the scrambling code group and offset associated thereto to complete frame synchronization.

### BRIEF DESCRIPTION OF THE DRAWINGS

FIG. 1 shows a portion of an illustrative wireless communications system in accordance with the principles of the invention;

FIGS. 2 and 3 show illustrative embodiments of a wireless receiver in accordance with the principles of the invention;

FIG. 4 shows an illustrative flow chart in accordance with the principles of the invention;

FIG. 5 shows an illustrative embodiment of a correlator structure in accordance with the principles of the invention;

FIG. 6 shows an illustrative matrix structure for storing correlator values in accordance with the principles of the invention;

FIG. 7 shows another illustrative flow chart in accordance with the principles of the invention;

FIG. 8 shows an illustrative metric matrix structure in accordance with the principles of the invention;

FIGS. 9, 10 and 11 further illustrate the matrices of FIGS. 6 and 8;

FIG. 12 shows an illustrative pseudo code implementation in accordance with the principles of the invention; and

FIGS. 13 and 14 show illustrative simulation results.

### DETAILED DESCRIPTION

Other than the inventive concept, the elements shown in the figures are well known and will not be described in detail. Also, familiarity with UMTS-based wireless communications systems is assumed and is not described in detail herein. For example, other than the inventive concept, spread spectrum transmission and reception, cells (base stations), user equipment (UE), downlink channels, uplink channels and RAKE receivers are well known and not described herein. In addition, the inventive concept may be implemented using conventional programming techniques, which, as such, will not be described herein. Finally, like-numbers on the figures represent similar elements.

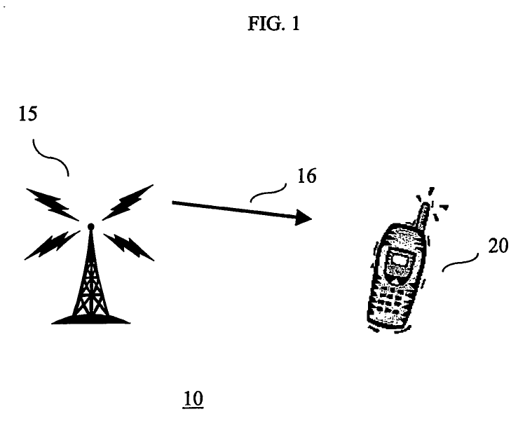

An illustrative portion of a UMTS wireless communications system 10 in accordance with the principles of the invention is shown in FIG. 1. Cell (or base station) 15 broadcasts a downlink synchronization channel (SCH) signal 16 including the above-mentioned PSCH and SSCH subchannels. As noted earlier, the SCH signal 16 is used by UMTS User Equipment (UE) for synchronization purposes as a pre-condition to voice/data communications. For example, the UE processes the SCH signal during a “cell search” operation. In this example, UE 20, e.g., a cellular phone, initiates a cell search when, e.g., UE 20 is turned on, or powered up. The purposes of the cell search operation include (a) determination of the scrambling code group of the cell (e.g., cell 15); and (b) synchronization to cell transmissions at the slot and frame level of the UMTS radio frame. As described below, and in accordance with the principles of the invention, UE 20 uses a soft decision technique for determining the scrambling code group and acquiring frame synchronization. It should be noted that although the following examples illustrate the inventive concept in the context of this initial cell search, i.e., when UE 20 is turned on, the inventive concept is not so limited and is applicable to other instances of the cell search, e.g., when the UE is in an “idle mode.”

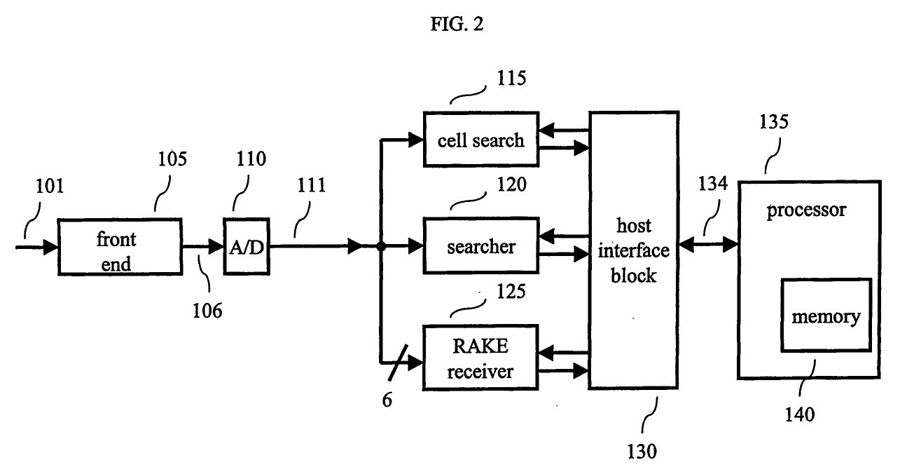

Turning now to FIG. 2, an illustrative block diagram of a portion of UE 20 in accordance with the principles of the invention is shown. UE 20 includes front end 105, analog-to-digital (A/D) converter 110, cell search element 115, searcher element 120, rake receiver 125, host interface block 130 and processor 135. It should also be noted that, other than the inventive concept, additional elements may be included within the blocks shown in FIG. 2 as known in the art but are not described herein for simplicity. For example, A/D converter 110 may include digital filters, buffers, etc.

Front end 105 receives a radio-frequency (RF) signal 101 transmitted from cell 15 (FIG. 1) via an antenna (not shown) and provides a base band analog signal 106 representing the PSCH and SSCH subchannels. Base band analog signal 106 is sampled by A/D converter 110, which provides a stream of received samples 111. The received samples 111 are available to three components: cell search element 115, searcher element 120 and rake receiver 125. Cell search element 115 processes the PSCH and SSCH subchannels in accordance with the principles of the invention as described further below. Subsequent to a successful cell search, searcher element 120 evaluates the received samples for the assignment of multipaths to each of the fingers of rake receiver 125, which, e.g., is capable of combining data from multiple paths in providing symbols for subsequent decoding by a decoder (not shown) to provide voice/data communications. Since only cell search element 115 is relevant to the inventive concept, search component 120 and rake receiver 125 are not described further herein. Host interface block 130 couples data between the three aforementioned components and processor 135, which, in this context, receives the results from cell search component 115 via signaling 134. Processor 135 is illustratively a stored-program controller processor, e.g., a microprocessor and includes memory 140 for storing programs and data.

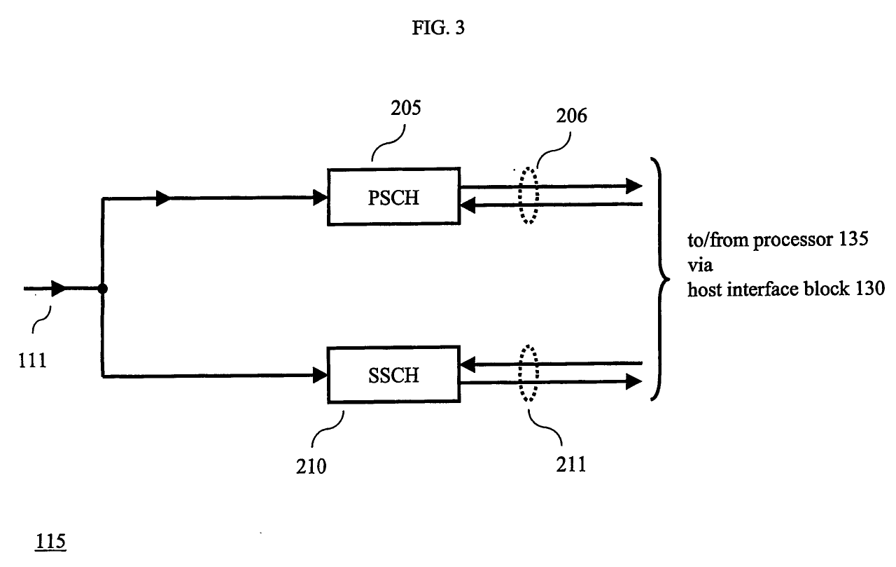

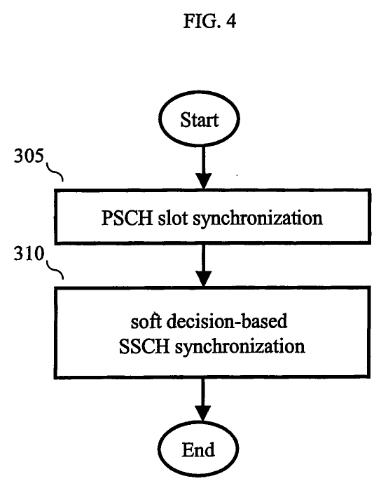

Turning now to FIG. 3, an illustrative block diagram of cell search element 115 is shown. Cell search element 115 includes PSCH element 205 and SSCH element 210. Reference should now also be made to FIG. 4, which shows an illustrative flow chart in accordance with the principles of the invention for processing the downlink PSCH and SSCH subchannels with cell search element 115 of FIG. 3. Processor 135 of UE 20 initiates the cell search in step 305 attempting to achieve slot synchronization by processing the downlink PSCH subchannel in step 305. In particular, processor 135 activates PSCH element 205, via signaling 206, to process the received samples 111 as known in the art. For example, since the downlink PSCH subchannel is a known PSCH 256 chip sequence, or PSCH code, that occurs periodically (i.e., repeats in every slot of the downlink SCH signal), PSCH element 205 correlates the received samples 111 against the PSCH code and provides an associated peak correlation value. In this regard, PSCH element 205 comprises a matched filter and a buffer (both not shown) that stores the output signal of the matched filter. PSCH element 205 provides the peak correlation value to processor 135 via signaling 206. This peak correlation value may be averaged over several slots of a received radio frame(s), e.g., between four and twenty slots, to decrease the probability of a “false lock.” (Since PSCH synchronization uses several slots—not frames—it is much quicker than the above-described SSCH frame synchronization of the prior art.) If the peak correlation value is not greater than a predefined threshold, processor 135 controls PSCH element 305 to continue processing any received signals to continue to look for a cell. However, if the peak correlation value is greater than a predefined threshold, UE 20 completes slot synchronization. An alternative method is to deem slot synchronization complete when the peak correlation value exceeds the next highest correlation value by a predefined additive or multiplicative factor.

Once slot synchronization is acquired in step 305, UE 20 must determine which one of 64 scrambling code groups is being used by cell 15, where each scrambling code group is identified by a particular sequence of 15 SSCH codes. As used herein, the 64 scrambling code groups form a set of scrambling code groups. In forming a scrambling code group, each SSCH code, or symbol, is taken from an alphabet of 16 symbols, e.g., 1 to 16. As such, an illustrative scrambling code group, e.g., Group 1, may include the following 15 SSCH symbols:
[1 1 2 8 9 10 15 8 10 16 2 7 15 7 16].
   While another scrambling code group, e.g., Group 2, may include the following 15 SSCH symbols:
[1 1 5 16 7 3 14 16 3 10 5 12 14 12 10].

In accordance with the principles of the invention, processor 135 determines the scrambling code group and acquires frame synchronization in accordance with a soft decision-based technique in step 310 of FIG. 4. In particular, and as described further below, processor 135 forms a set of metrics (metric set) for each one of the scrambling code groups, where each metric set includes a plurality of metric values, each metric value associated with a particular cyclic shift of the respective scrambling code group. Processor 135 then selects the largest metric value from all of the metric sets. The particular metric set, from which the largest value was selected, identifies the scrambling code group and the cyclic shift, which corresponds to the selected metric value, determines the frame offset for acquiring frame synchronization. It should also be noted that, for simplicity, error conditions are not shown in the flow charts described herein. For example, should UE 20 lose slot synchronization while attempting frame synchronization, the above-described cell search is, unfortunately, restarted.

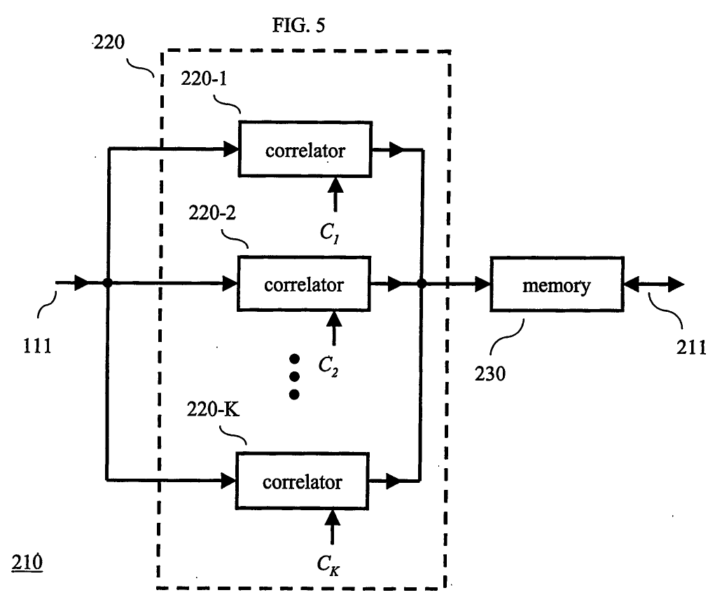

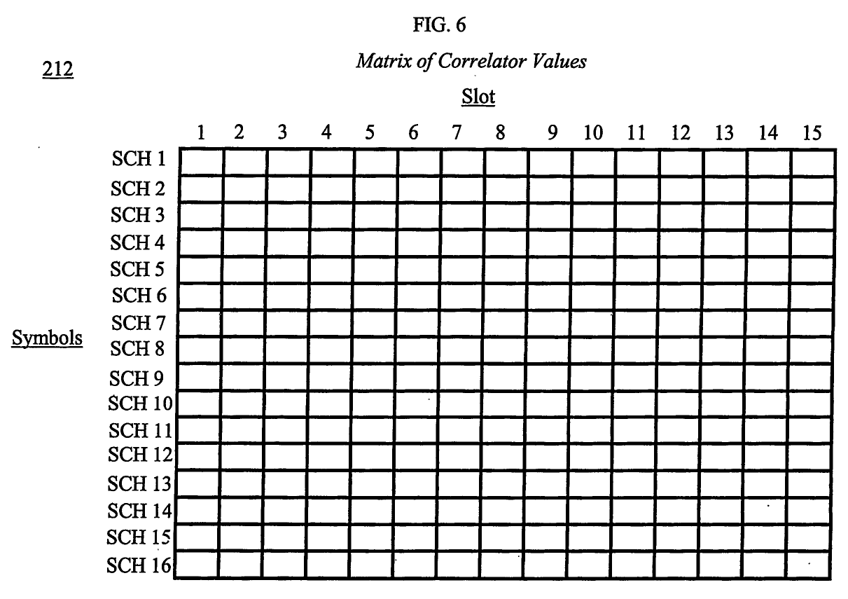

In accordance with an aspect of the invention, an illustrative structure for SSCH element 210 is shown in FIG. 5. SSCH element 210 comprises a correlator bank 220, including K correlators, 220-1 to 220-K, and a memory 230. Each correlator correlates received samples 111 in a time slot to a respective one of a number of codewords, C₁ to C_{K}. As such, correlator bank 220 provides K correlator values every time slot to memory 230. The latter stores correlator values over S received time slots, i.e., memory 230 stores S×K correlator values. It should be noted that other memories, e.g., memory 140, may also be used to store the correlator values. Illustratively, in this example the codewords are SSCH codes, K=16, i.e., there is one correlator for each possible value of an SSCH code, S=15, and memory 230 stores a frame worth of correlator values, i.e., 240 values. The storage of the correlator values in memory 230 over a frame is illustratively organized as a matrix, or table, of correlator values, 212, as shown in FIG. 6. For simplicity only the form of matrix 212 is shown in FIG. 6, i.e., no actual correlator peak values are indicated in the individual cells of matrix 212. Each row of matrix 212 corresponds to one of the 16 SSCH codes, SSCH 1 to SSCH 16; and each column corresponds to one of the 15 time slots, slot 1 to slot 15. In other words, each column stores the correlator values representing, in effect, the probability, or confidence indicator, that a particular one of the SSCH codes was received in that time slot. For example, if SSCH Code 1 had a correlation peak of 1000 for a particular time slot and SSCH Code 2 had a correlation peak of just 500 for the same time slot then there is much more confidence that SSCH Code 1 was transmitted rather than SSCH Code 2 in that time slot. Therefore, and in accordance with an aspect of the invention, the matrix of correlator values collects and retains information related to all of the possibly received SSCH codes over at least one frame and, thus, as described below, provides an improved ability to acquire the SSCH channel when operating under severe channel conditions.

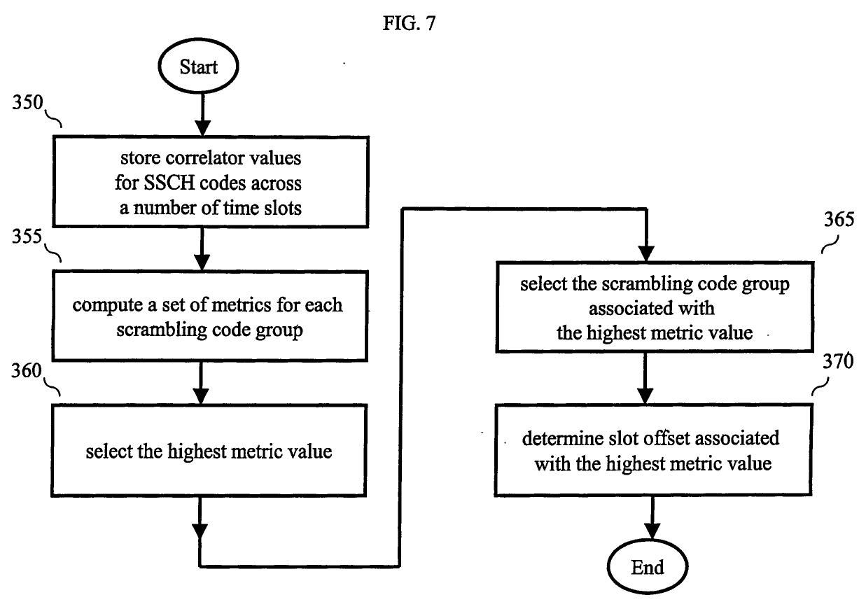

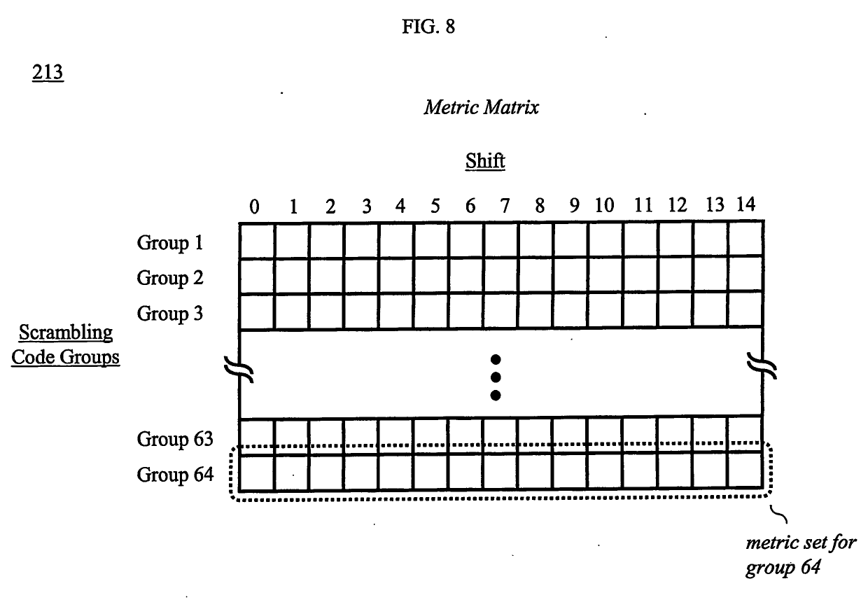

Turning now to FIG. 7, an illustrative flow chart, in accordance with the principles of the invention, is shown for use in implementing step 310 of FIG. 4. In particular, in step 350, SSCH element 210 stores a plurality of correlation values for each one of the possibly-received SSCH codes over at least one frame, i.e., 15 time slots, in the above-described matrix of correlator values 212. (It should be noted that multiple frames worth of correlation data may be accumulated and stored in the matrix of correlator values.) In step 355, processor 135 accesses memory 230, via signaling path 211 of FIG. 3, and uses the values stored in the matrix of correlator values 212 to determine a matrix, or table, of metric values (a metric matrix). An illustrative metric matrix 213 is shown in FIG. 8. Again, for simplicity only the structure of matrix 213 is shown in FIG. 8, i.e., no actual metric values are indicated in the individual cells of matrix 213. Each row of the metric matrix corresponds to one of the predefined scrambling code groups and each column of the metric matrix corresponds to a particular cyclic shift of the scrambling code group. As can be observed from FIG. 8, each entry in the metric matrix associates a metric value with a particular cyclic shift of a particular scrambling code group. Thus, each row of the metric matrix, i.e., each scrambling code group, is associated with a metric set, which includes a plurality of metric values associated with different cyclic shifts of the scrambling code group as shown in FIG. 8 for group 64. Processor 135 determines each metric value for a given shift of a given scrambling code group as the sum of the confidence values for that sequence. After the metric matrix has been determined, processor 135 then selects the highest metric value in the metric matrix in step 360. Since each metric value is associated with a particular cyclic shift of a particular scrambling code group, processor 135 selects the scrambling group associated with the highest metric value (i.e., the associated row) in step 365 and determines the slot offset associated with the highest metric value (i.e., the associated column) in step 370 to complete frame synchronization.

As a further illustration, consider the following simplified example. Assume that an SSCH code alphabet comprises four codes, or symbols, {1, 2, 3, 4}, and that the number of time slots in every frame is two. Further assume that the following scrambling code groups are predefined as:
Group 1=[1, 4],
Group 2=[1, 2],
Group 3=[3, 1], and
Group 4=[2, 3].
   For example, from the above-definition Group 1 is defined as the SSCH symbol sequence 1, 4.

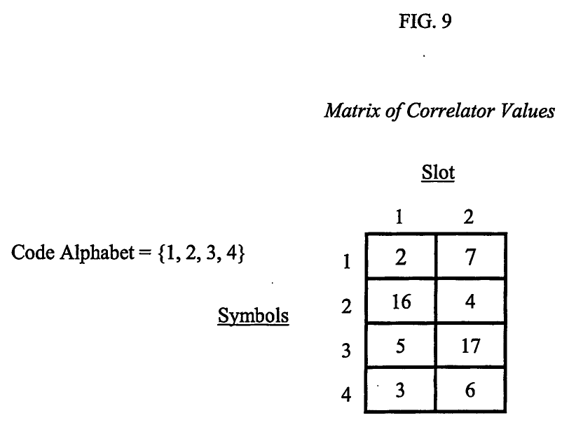

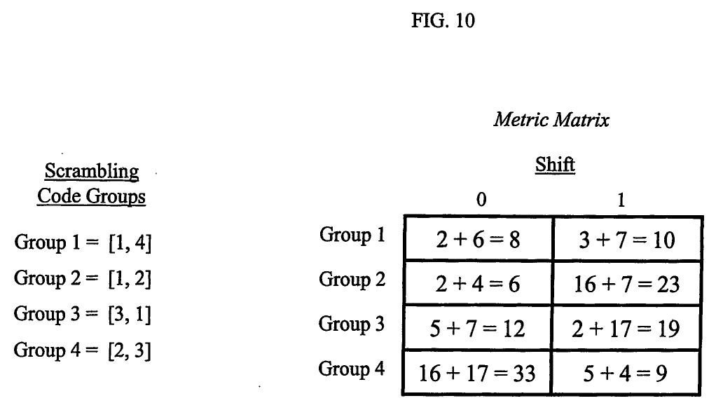

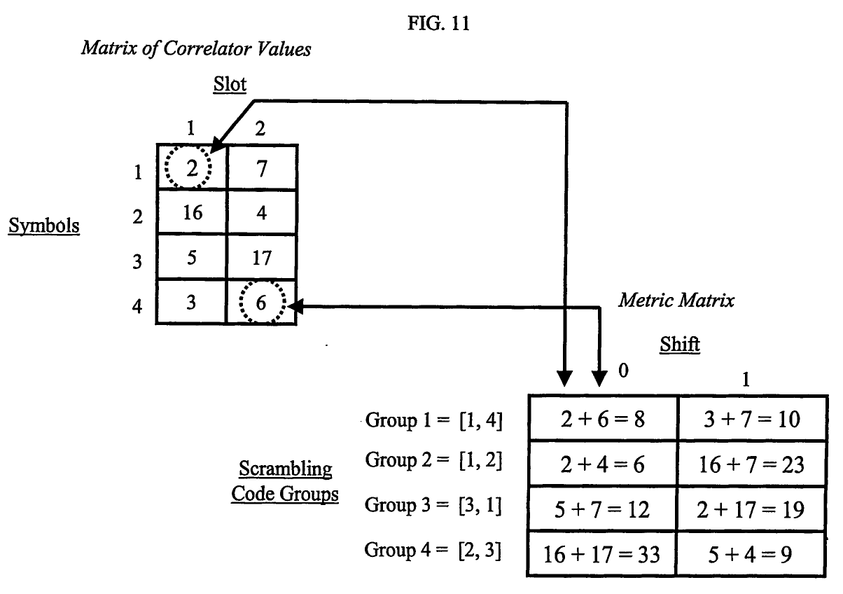

As such, SSCH element 210 includes four correlators, each correlator comparing the received samples 111 in a time slot to a respective one of the four possible symbols {1, 2, 3, 4}. In accordance with step 350 of FIG. 7, SSCH element 210 stores a plurality of correlation peak values for each one of the possibly-received SSCH codes in each of two time slots in the matrix of correlator values. An illustrative matrix of correlator values is shown in FIG. 9 for a particular two time slots. As can be observed from FIG. 9, for symbol 1 a correlator value of 2 is associated with the possibility that symbol 1 was received in the first time slot, while a correlator value of 7 is associated with the possibility that symbol 1 was received in the second time slot, etc. Then, and in accordance with step 355 of FIG. 7, processor 135 forms the metric matrix as shown in FIG. 10 for each scrambling code group. For example, for Group 1, processor 135 first determines the metric associated with a cyclic shift of zero. This is performed by reference to the matrix of correlator values and adding the correlator value associated with symbol 1 in the first time slot (a value of 2) to the correlator value associated with symbol 4 in the second time slot (a value of 6) to yield a metric value of 8. This computation is further illustrated in FIG. 11. Processor 135 then determines the remainder of the metric values in a similar fashion. For example, for Group 1 the metric associated with a cyclic shift of 1, i.e., the possibility that the received sequence is actually [4, 1] is equal to 10, etc.

Continuing with this example, and returning to FIG. 7, after the metric matrix has been determined, processor 135 then selects the highest metric value in the metric matrix in step 360. In the example, this is the value of 33. As can be observed from FIG. 10, the value of 33 corresponds to the row associated with Group 4 and the column associated with a shift of 0. Thus, processor 135 selects Group 4 as the scrambling code group in step 365 and determines a shift of zero is required for frame synchronization in step 370.

Once SSCH processing is successfully completed in step 370, the identification of the scrambling code group of cell 15 enables UE 20 to descramble all of the other downlink channels of the cell (including, e.g., the Common Pilot Channel (CPICH), which is used for frequency synchronization and also to determine the actual scrambling code for the cell from the identified scrambling code group) and voice/data communications can begin.

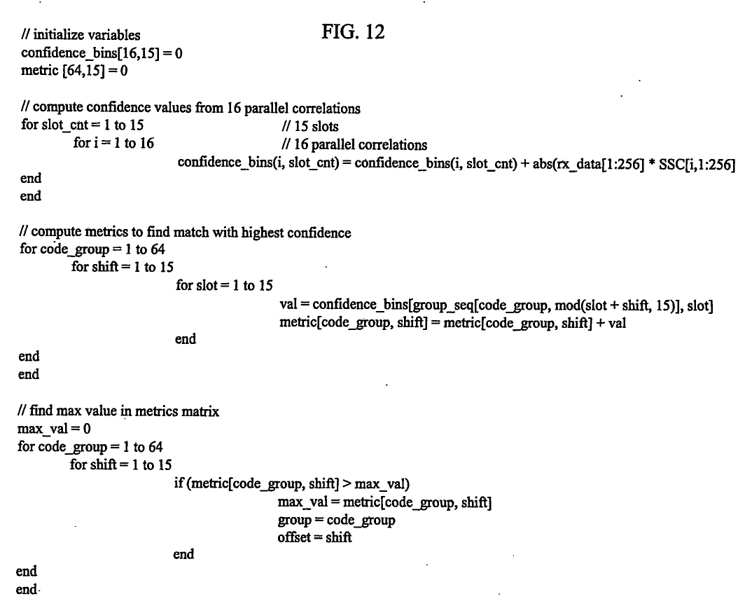

Turning now to FIG. 12, an illustrative pseudo-code implementation in accordance with the principles of the invention is shown. In the pseudo-code of FIG. 12, the notation rx_data is the received 256 samples for a given slot, SSC[i,j] is the j-th sample in the i-th SSCH code, group_seq is a matrix look-up table of all 64 possible scrambling code group sequences, group is the identified transmitted code group and offset is the frame slot offset.

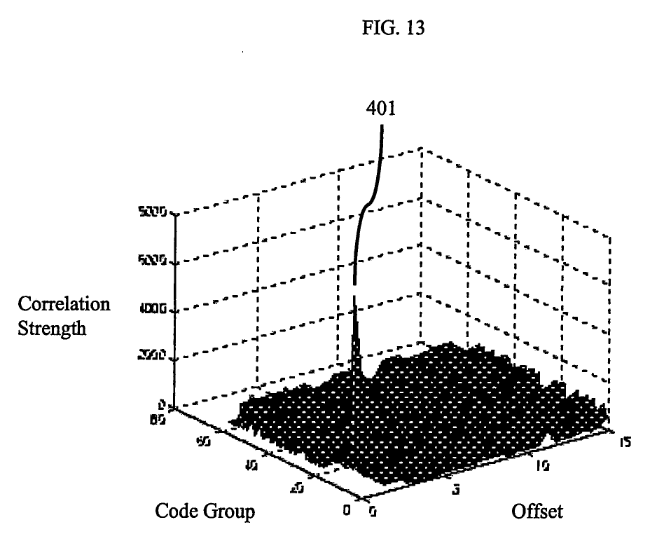

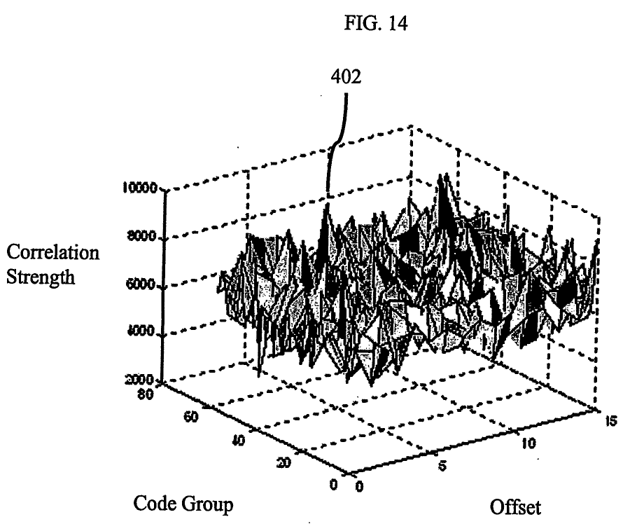

FIGS. 13 and 14 illustrate simulation results for a UMTS receiver in accordance with the principles of the invention. FIG. 13 shows simulation results for the case of no noise. In FIG. 13, the values represent the metric values of the metric matrix. The large peak 401 represents the largest metric value and identifies scrambling code group number 10 with an offset of 0, which is the correct group and offset. In contrast, FIG. 14 shows simulation results for the case of a very low signal-to-noise ratio. Again, in FIG. 14, the values represent the metric values of the metric matrix. The large peak 402 represents the largest metric value and identifies scrambling code group number 10 with an offset of 0, which, again, is the correct group and offset. Although the metrics of FIG. 14 look noisy, the highest peak 402 is actually 11% higher than the next highest peak. It should be noted that for the same simulation as illustrated in FIG. 14, a typical hard decision algorithm failed and incorrectly identified Group 2 with an offset of 1. Thus, the soft decision approach in accordance with the inventive concept is able to perform better in severe channel conditions since, unlike a hard decision-based approach, the soft decision-based technique described herein does not discard information, or data, about possibly received SSCH codes.

As described above, and in accordance with the principles of the invention, a wireless receiver uses a soft decision-based technique for determining the scrambling code group and acquiring frame synchronization. This soft decision-based technique provides a method and apparatus for robust secondary cell search in a UMTS receiver. Indeed, although extra storage, or memory, space is required, the tradeoff is that the wireless receiver will have an improved ability to acquire the SSCH channel when operating under severe channel conditions (e.g., a very low signal-to-noise ratio). Although described in the context of the initial cell search process, the inventive concept is applicable to any portion of wireless operation in which a downlink channel, such as the SSCH subchannel, is processed.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs) and/or in one or more stored program-controlled processors (e.g., a microprocessor or digital signal processor (DSP)). Similarly, although illustrated in the context of a UMTS-based system, the inventive concept is applicable to other communications system. It is therefore to be understood that numerous modifications may be made to the illustrative embodiments and that other arrangements may be devised without departing from the spirit and scope of the present invention as defined by the appended claims.

1. A method for use in a wireless receiver, comprising:
receiving a signal representing S symbols over a number of time slots, where the S symbols are associated with a synchronization word taken from a set of M synchronization words, where S>I and M>I; and
acquiring frame synchronization with respect to the number of time slots by estimating the associated synchronization word as a function of metric values associated with each of the M synchronization words.

2. The method of claim 1, wherein the acquiring frame synchronization step includes:
storing K correlator values for each time slot, each correlator value representing a correlation of the received signal in one of the S time slots with each one of K possibly received symbols, where K>I;
determining a set of metrics for each of the M synchronization words from the stored correlator values;
selecting a highest metric value from all of the determined sets of metrics; and
determining from the selected highest metric value (a) one of the M synchronization words as the estimate of the received synchronization word and (b) a time slot offset for acquiring frame synchronization with respect to the number of time slots.

3. The method of claim 2, wherein each of the M synchronization words includes a unique sequence of symbols, and wherein for each of the M synchronization words the determining a set ol metrics step includes the steps of:
performing S cyclic shifts of the synchronization word; and
for each cyclic shift, adding together respective correlator values associated with that pattern of symbols in each of the S time slots.

4. The method of claim 1, wherein each symbol is a secondary synchronization channel (SSCH) symbol of a universal mobile telephone system (UMTS), and the M synchronization words are 64 scrambling code group sequences.

5. The method of claim 4, wherein the acquiring frame synchronization step includes:
forming a matrix of correlation peak values from the received synchronization word, each row of the matrix being associated with one of a plurality of possibly received SSCH symbols, and each column of the matrix being associated with one of the number of time slots wherein each correlator peak value represents a correlation between a respective one of the S received symbols in the corresponding time slot with a respective one of the plurality of possibly received SSCH symbols;
forming a metric value for each cyclic shift of each one of the 64 scrambling code groups from the matrix of correlation peak values;
identifying the highest metric value; and
determining from the identified highest metric value (a) one of the 64 scrambling code group sequences as the estimate of the received synchronization word and (b) the associated cyclic shift for use in acquiring frame synchronization with respect to the number of time slots.

6. The method of claim 5, wherein the forming a metric value step includes the steps of:
forming a metric matrix, each row of the metric matrix being associated with one of the 64 scrambling code groups and each column of the metric matrix being associated with a cyclic shift; and
determining each metric value by adding corresponding correlator peak values associated with a particular cyclic shift of a particular scrambling code group:

7. A method for use in a universal mobile telephone system (UMTS) receiver, comprising:
receiving a signal representing a secondary synchronization channel (SSCH) transmitted from a UMTS transmitter, the SSCH conveying a sequence of S SSCH symbols over S time slots, the sequence associated with a scrambling code group associated with the UMTS transmitter, wherein the scrambling code group is taken from a set of 64 scrambling code groups;
storing data representative of probabilities that each one of K SSCH symbols were received in each one of the S thie slots, where K>I;
determining metric values from the stored data, each metric value representing a probability that a particular cyclic shift of a particular one of the 64 scrambling code groups was received;
identifying the highest metric value; and
determining from the highest metric value (a) the associated scrambling code group as the scrambling code group of the UMTS transmitter and (b) a time slot offset from the associated cyclic shift for use in acquiring frame synchronization with respect to the S time slots.

8. The method of claim 7, wherein the storing data step includes:
correlating each one of the K SSCH symbols with the received signal in each of the S time slots to provide K corresponding correlator values; and
storing the K corresponding correlator values associated with each of the S time slots.

9. Universal Mobile Telephone System (UMTS) equipment comprising:
a front end for receiving a wireless signal representing a secondary synchronization channel (SSCH) transmitted from a UMTS transmitter and for providing a stream of samples therefrom, the SSCH conveying a sequence of S SSCH symbols over S time slots, the sequence associated with a scrambling code group associated with the UMTS transmitter, wherein the scrambling code group is taken from a set of 64 scrambling code groups;
a memory for storing data representative of probabilities that each one of K SSCH symbols were received in each one of the S time slots, where K>I; and
a processor for (a) determining metric values from the stored data, each metric value representing a probability that a particular cyclic shift of a particular one of the 64 scrambling code groups was received; (b) identifying the highest metric value; and (c) determining from the highest metric value (1) the associated scramnbling code group as the scrambling code group of the UMTS transmitter and (2) a time slot offset from the associated cyclic shift for use in acquiring frame synchronization with respect to the S time slots.

10. The UMTS equipment of claim 9, wherein the data. representative of probabilities are correlator values and further comprising a bank of correlators for (a) correlating each one of the K SSCH symbols with the samples associated with each of the S time slots to provide K corresponding correlator values; and (b) storing the K corresponding correlator values associated with each of the S time slots in the memory.

11. The UMTS equipment of claim 10, wherein the processor determines the metric value of each particular cyclic shift of a scrambling code group by adding together respective correlator values associated with that pattern of symbols in each of the S time slots.

12. Apparatus for use in a wireless receiver, the apparatus comprising:
a front end for receiving a wireless signal representing a sequence of frames, and for providing a stream of samples therefrom, each frame conveying a sequence of symbols over a number of time slots, the sequence a priori being associated with a source of the wireless signal;
a memory for storing a table of metric values, each row of the table being associated with one of M sequences of synchronization symbols, M>I, and each column of the table being associated with a cyclic shift of the M sequences; and
a processor for (a) identifying the highest metric value stored in the table of metric values, (b) determining from the identified highest metric value (1) one of the M sequences of synchronization symbols as an estimate of the received sequence of symbols and (2) the associated cyclic shift for use in acquiring frame synchronization with respect to the received wireless signal.

13. The apparatus of claim 12, further comprising a memory for storing a table of correlation values, each row of the table being associated with one of a plurality of possibly received symbols, and each column of the table being associated with one of the number of time slots wherein each correlation value represents a correlation between the samples in the corresponding time slot with a respective one of the plurality of possibly received symbols and wherein the table of metric values is derived from the table of correlation values.

14. The apparatus of claim 13, wherein the processor determines the stored metric value of each particular cyclic shift of each of the M sequences by adding together respective correlation values associated with that pattern of symbols in each of the S time slots.
